(19) United States
(12) Patent Application Publication
(10) Pub. No.: US 2026/0204115 A1
(43) Pub. Date: Jul. 16, 2026

(54) INTELLIGENT DOOR BARRIER AND CONTROL METHOD THEREFOR

(71) Applicant: Ningbo Kony Metal Products Co., Ltd., Cixi (CN)

(72) Inventor: Guowen LIN, Fuqing (CN)

(21) Appl. No.: 19/426,310

(22) Filed: Dec. 19, 2025

(30) Foreign Application Priority Data
Jan. 10, 2025 (CN) 202520059380X
Jan. 10, 2025 (CN) 2025100425283
Jan. 10, 2025 (CN) 2025100425387

(51) Int. Cl. G07C 9/00; E05B 47/00; E05F 15/70; E06B 9/00

(52) U.S. Cl. CPC G07C 9/00563; E05B 47/0002; E05F 15/70; E06B 9/00; E05B 2047/0056; E06B 2009/002

(57) ABSTRACT

The present disclosure belongs to the technical field of door barrier processing and manufacturing and discloses an intelligent door barrier. The intelligent door barrier includes an openable and closable door barrier; an electromagnetic lock, controlling locking of the door barrier; a controller, electrically connected to the electromagnetic lock to control magnetic on-off of the electromagnetic lock; and a voice control module, electrically connected to the controller, where the controller receives a signal sent by the voice control module and controls opening and closing of the door barrier; and the voice control module is provided with a switch, which controls on-off of the voice control module. The door barrier body is opened and closed through voices, and the switch, which controls on-off of the voice control module, may activate or deactivate the voice control module.

### CROSS-REFERENCE TO RELATED APPLICATIONS

This application claims priorities from the Chinese patent applications 2025100425283 filed Jan. 10, 2025; 2025100425387 filed Jan. 10, 2025; and 202520059380X filed Jan. 10, 2025, the content of which are incorporated herein in the entirety by reference.

### TECHNICAL FIELD

The present disclosure relates to the technical field of door barrier processing and production, and in particular to an intelligent door barrier and a control method therefor.

### BACKGROUND

Currently, many families have both infants and pets or are fond of pets. To prevent pets from roaming around every room, these families tend to confine the pets to a single room. A door barrier is disposed at an entrance of a room, and both ends of the door barrier are fixed to a door frame. However, the door barrier in the prior art needs to be opened or closed manually. If no one is at home, the door barrier cannot be opened in a timely manner to release the pets.

### SUMMARY

To solve the above technical problem, the present disclosure provides an intelligent door barrier and a control method therefor, which may achieve remote door opening, making operations more convenient.

To achieve the above objective, in a first aspect, the technical solution adopted by the present disclosure is as follows: an intelligent door barrier, including:
an openable and closable door barrier;
an electromagnetic lock, disposed at an entrance of the openable and closable door barrier to control locking of the door barrier;
a controller, electrically connected to the electromagnetic lock to control magnetic on-off of the electromagnetic lock, where the electromagnetic lock feeds a state of the door barrier back to the controller; and
a voice control module, electrically connected to the controller, wherein the controller receives a signal sent by the voice control module and controls opening and closing of the door barrier; the voice control module is provided with a switch, which controls on-off of the voice control module. The door barrier body is opened and closed through voices, and the switch, which controls on-off of the voice control module, may activate or deactivate the voice control module. When the voice control module is deactivated, the door may be opened in other ways, which prevents children from imitating adults to issue door-opening instructions, thereby preventing the door from being accidentally opened.

According to the present disclosure, the intelligent door barrier further includes a mobile terminal, electrically connected to the controller to remotely control the controller, so as to achieve remote control of opening and closing of the door barrier body.

According to the present disclosure, further, a motor is connected to an opening and closing hinge joint of the openable and closable door barrier, and a hinge shaft is driven by the motor to rotate, to achieve opening and closing of the door barrier.

According to the present disclosure, the intelligent door barrier further includes an indicating component electrically connected to the controller, where the indicating component is configured to display different colors when the door barrier body is closed or opened, or to send out a prompt tone in an unclosed state.

According to the present disclosure, the intelligent door barrier further includes an infrared induction switch electrically connected to the controller, where the infrared induction switch automatically controls opening of the door barrier body by sensing infrared heat emitted from outside.

According to the present disclosure, the intelligent door barrier further includes a fingerprint touch panel electrically connected to the controller, where the electromagnetic lock is unlocked through fingerprint recognition to achieve opening of the door barrier body.

According to the present disclosure, the intelligent door barrier further includes a remote controller electrically connected to the controller, where the remote controller transmits an opening and closing signal to the controller, so as to control on-off of the electromagnetic lock.

According to the present disclosure, the intelligent door barrier further includes a camera, where an image captured by the camera is fed back to the mobile terminal, and the captured image is viewed in real time through the mobile terminal.

According to the present disclosure, the intelligent door barrier further includes a wireless fidelity (WIFI) module, which implements wireless network connections among electronic modules.

In a second aspect, the present disclosure further provides a method for controlling an intelligent door barrier, where one of the voice control module, the infrared induction switch, the fingerprint touch panel, the remote controller or a manual door opening mode is selected.

Compared with the prior art, the present disclosure has the following beneficial effects:
1. By disposing the mutually cooperative electromagnetic lock and controller, remote door opening is achieved through the mobile terminal, such that the operating convenience is improved.
2. The electromagnetic lock provided by the present disclosure may achieve opening and closing of the door barrier body through the magnetic attraction structure. By forming the groove and the protrusion cooperating with the groove, the door closing accuracy is further enhanced. When contacting the groove, the protrusion will slide along the arc-shaped inner wall to the lowest point of the groove, and further cooperates with the magnetic attraction structure to improve the accuracy of the vertex of the protrusion falling into the lowest point of the groove.

### BRIEF DESCRIPTION OF THE DRAWINGS

FIG. 1 is a schematic structural view of an intelligent door barrier of the present disclosure.

FIG. 2 is a schematic diagram of an electronic control portion of the present disclosure.

### REFERENCE SIGNS IN THE DRAWINGS

100, door barrier frame;
200, door barrier body;
300, electromagnetic lock;
310, indicator light;
400, infrared induction switch;
500, fingerprint touch panel;
600, controller;
700, voice control module;
800, remote control module;
900, camera.

### DETAIL DESCRIPTION OF THE EMBODIMENTS

The following description is used to disclose the present disclosure, such that those skilled in the art can implement the same. The preferred embodiments in the following description are merely illustrative, and other obvious variations will occur to those skilled in the art.

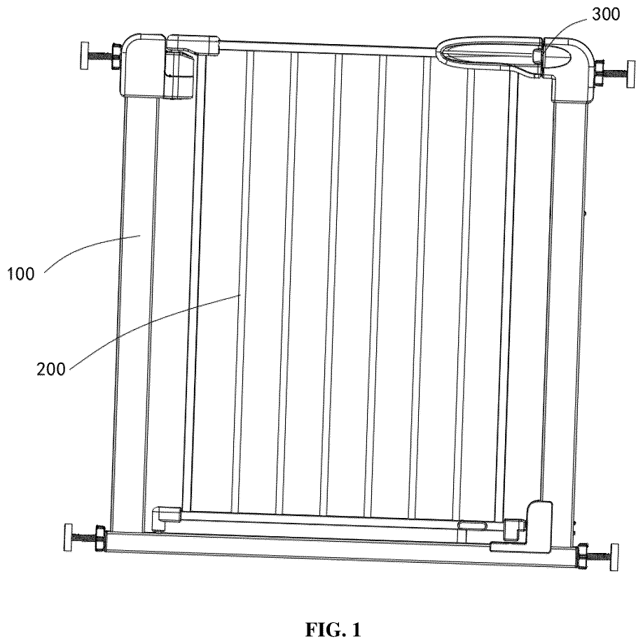

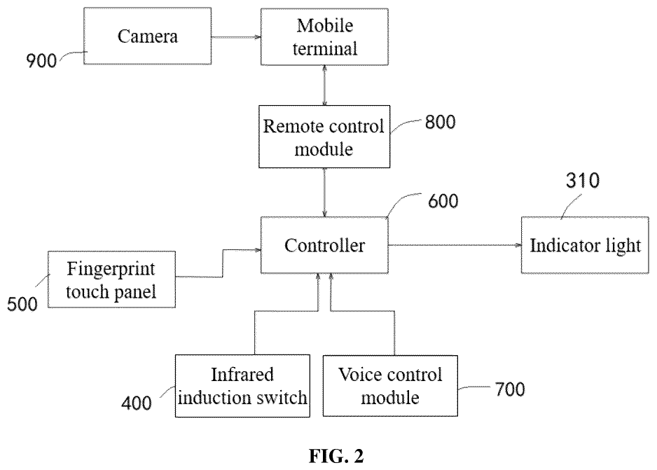

As shown in FIGS. 1-2, an intelligent door barrier includes a door barrier frame 100 fixed to a door frame, where both sides of the door barrier frame 100 are fixedly connected to the door frame on a corresponding side, the door barrier frame 100 is configured to mount a door barrier body 200, and the door barrier body 200 swings forward and backward relative to the door barrier frame 100 to open and close the door barrier body 200. The forward and backward swinging direction herein refers to an opening and closing direction of the door barrier body 200. Preferably, the door barrier frame 100 is composed of square tubes, which is high in stability, light in weight, and convenient to transport and mount.

One side of the door barrier body 200 is hinged to the door barrier frame 100, such that the door barrier body 200 swings forward and backward, and therefore, the door barrier body 200 is opened and closed. Preferably, the hinge mode adopts a rotating shaft connection. A motor (not shown in the figures) is connected to a hinge joint between the door barrier body 200 and the door barrier frame 100, and the door barrier body 200 is controlled by the motor to open and close; an output shaft of the motor is connected to the rotating shaft at the hinge joint between the door barrier body and the door barrier frame, and the opening and closing speed of the door barrier body is adjusted by adjusting the rotating speed of the motor. The door barrier body 200 is rectangular. Preferably, the door barrier body 200 is a fence type, through which pets may be blocked, observed, and fed without detaching the door barrier body 200.

An electromagnetic lock 300 controlling on-off of magnetic poles by a controller 600 is disposed on a relative opening and closing side of the door barrier body 200 and the door barrier frame 100. The controller 600 receives a door opening signal and de-energizes the magnetic poles of the electromagnetic lock 300 to cut off the electromagnetic lock 300. The controller 600 receives a door closing signal and energizes the magnetic poles of the electromagnetic lock 300 to energize the electromagnetic lock 300. The electromagnetic lock 300 feeds a state signal back to the controller 600. The door barrier body 200 and the door barrier frame 100 may be precisely closed by means of magnetism. The controller 600 may further set a time to open and close the door. At a preset time, the controller automatically sends a signal to the electromagnetic lock 300 to control the time to open and close the door.

To further improve the door closing accuracy and the door closing firmness, a groove and a protrusion cooperating with the groove are respectively disposed on a surface of the relative opening and closing side of the door barrier body 200 and the door barrier frame 100, two magnet components with opposite magnetic poles are respectively disposed in the groove and at a vertex of the protrusion, and when contacting the groove, the protrusion will slide along an arc-shaped inner wall to the lowest point of the groove, and further cooperates with a magnetic attraction structure to improve the accuracy of the vertex of the protrusion falling into the lowest point of the groove, such that the door is more precisely closed; in the door closing process, opposite poles attract each other, and the protrusion is precisely embedded into the groove to achieve precise door closing, thereby improving the door closing accuracy. Preferably, the intelligent door barrier includes an indicator light 310 electrically connected to the controller 600. The indicator light 310 is configured to display different colors when the door barrier body 200 and the door barrier frame 100 are closed or opened, which is convenient to confirm the opening and closing state of the door barrier body 200. Specifically, the controller 600 feeds the received state signal of the electromagnetic lock 300 back to the indicator light 310 to turn off or on the indicator light displaying different colors. Preferably, the indicator light 310 is a red-green indicator light, where red represents that the door is locked, and green represents that the door is opened. The indicator light may be also replaced with an alarm device or another component with a warning effect.

An infrared induction switch 400 electrically connected to the controller 600 is disposed on the door barrier body 200 or the door barrier frame 100, where an automatic control function of the infrared induction switch is achieved by sensing infrared heat emitted from outside, such that the door barrier body 200 can be opened quickly. A fingerprint touch panel 500 electrically connected to the controller 600 may be further disposed, where the electromagnetic lock 300 is unlocked through fingerprint recognition to achieve opening of the door barrier body 200. The intelligent door barrier may further include a remote controller electrically connected to the controller 600 and controlling on-off of the magnetic poles of the electromagnetic lock 300. The remote controller transmits an opening and closing signal to the controller 600 to control on-off of the magnetic poles of the electromagnetic lock 300. Within a certain area, if a person cannot open the door in a timely manner, he/she can carry the remote controller with himself/herself and realize the opening and closing of the door barrier body 200 by pressing a door opening button or a door closing button on the remote controller.

In the embodiment of the present application, a voice control module 700 electrically connected to the controller 600 may further be disposed. The door barrier body 200 is opened and closed through voices. The intelligent door barrier further includes a switch controlling on-off of the voice control module 700. The switch may activate or deactivate the voice control module 700. When the voice control module 700 is deactivated, the door can only be opened by way of remote control, face recognition, and manual operations, which prevents children from imitating adults to issue door-opening instructions, thereby preventing the door from being accidentally opened.

To remotely control opening and closing the door barrier body 200, the intelligent door barrier further includes a remote control module 800 electrically connected to the controller 600. A corresponding APP is installed in the mobile terminal to operate a corresponding door opening or closing button, so as to achieve opening and closing of the door barrier body 200. To acquire information of opening and closing the door barrier body 200 in real time, a camera 900 is mounted on the door barrier body 200 or the door barrier frame 100. An image captured by the camera 900 is fed back to the mobile terminal. Whether the door barrier body 200 is opened or closed is decided according to the image captured by the mobile terminal. The state of pets may be observed, and opening and closing of the door barrier body 200 may also be remotely controlled.

A WiFi module may further be mounted on the intelligent door barrier to achieve a wireless network connection. The WiFi module belongs to the prior art, which is not repeatedly described.

The above shows and describes the basic principles, main features and advantages of the present disclosure. Those skilled in the art should understand that the present disclosure is not limited to the above-described embodiments. The above-described embodiments and the descriptions in the specification merely illustrate the principles of the present disclosure. Various changes and improvements may be made to the present disclosure without departing from the spirit and scope thereof, and all such changes and improvements fall within the scope of protection claimed by the present disclosure. The scope of protection claimed by the present disclosure is defined by the appended claims and equivalents thereof.

1. An intelligent door barrier, comprising a door barrier frame fixed to a door frame, wherein both sides of the door barrier frame are fixedly connected to the door frame on a corresponding side, the door barrier frame is configured to mount a door barrier body, and one side of the door barrier body is hinged to the door barrier frame; a motor is connected to a hinge joint, and a hinge shaft is driven by the motor to rotate, to achieve opening and closing of the door barrier;
an electromagnetic lock, disposed on a relative opening and closing side of the door barrier body and the door barrier frame to control locking of the door barrier;
a controller, electrically connected to the electromagnetic lock to control magnetic on-off of the electromagnetic lock, wherein the electromagnetic lock feeds a state of the door barrier back to the controller; and
a voice control module, electrically connected to the controller, wherein the controller receives a signal sent by the voice control module and controls opening and closing of the door barrier; the voice control module is provided with a switch, which controls on-off of the voice control module; a groove and a protrusion cooperating with the groove are respectively disposed on a surface of the relative opening and closing side of the door barrier body and the door barrier frame, two magnet components with opposite magnetic poles are respectively disposed in the groove and at a vertex of the protrusion, and when contacting the groove, the protrusion will slide along an arc-shaped inner wall to the lowest point of the groove, and further cooperates with a magnetic attraction structure to improve an accuracy of the vertex of the protrusion falling into the lowest point of the groove.

2. The intelligent door barrier according to claim 1, wherein the motor is mounted at any position except for the hinge joint.

3. The intelligent door barrier according to claim 1, further comprising a mobile terminal, electrically connected to the controller to remotely control the controller, so as to achieve remote control of opening and closing of the door barrier body.

4. The intelligent door barrier according to claim 1, further comprising an indicating component electrically connected to the controller, wherein the indicating component is configured to display different colors when the door barrier body is closed or opened or send out a prompt tone in an unclosed state.

5. The intelligent door barrier according to claim 1, further comprising an infrared induction switch electrically connected to the controller, wherein the infrared induction switch automatically controls opening of the door barrier body by sensing infrared heat emitted from outside.

6. The intelligent door barrier according to claim 1, further comprising a fingerprint touch panel electrically connected to the controller, wherein the electromagnetic lock is unlocked through fingerprint recognition to achieve opening of the door barrier body.

7. The intelligent door barrier according to claim 1, further comprising a remote controller electrically connected to the controller, wherein the remote controller transmits an opening and closing signal to the controller, so as to control on-off of the electromagnetic lock.

8. The intelligent door barrier according to claim 2, further comprising a camera, wherein an image captured by the camera is fed back to the mobile terminal, and the captured image is viewed in real time through the mobile terminal.

9. The intelligent door barrier according to claim 1, further comprising a wireless fidelity (WIFI) module, which implements wireless network connections among electronic modules.

10. A method for controlling the intelligent door barrier according to claim 1, wherein the controller is electrically connected to at least one of the voice control module, the infrared induction switch, the fingerprint touch panel, and the remote controller; and one of door opening modes of the voice control module, the infrared induction switch, the fingerprint touch panel, and the remote controller is selected.

11. The method of claim 10, wherein the motor is mounted at any position except for the hinge joint.

12. The method of claim 10, further comprising a mobile terminal, electrically connected to the controller to remotely control the controller, so as to achieve remote control of opening and closing of the door barrier body.

13. The method of claim 10, further comprising an indicating component electrically connected to the controller, wherein the indicating component is configured to display different colors when the door barrier body is closed or opened or send out a prompt tone in an unclosed state.

14. The method of claim 10, further comprising an infrared induction switch electrically connected to the controller, wherein the infrared induction switch automatically controls opening of the door barrier body by sensing infrared heat emitted from outside.

15. The method of claim 10, further comprising a fingerprint touch panel electrically connected to the controller, wherein the electromagnetic lock is unlocked through fingerprint recognition to achieve opening of the door barrier body.

16. The method of claim 10, further comprising a remote controller electrically connected to the controller, wherein the remote controller transmits an opening and closing signal to the controller, so as to control on-off of the electromagnetic lock.

17. The method of claim 11, further comprising a camera, wherein an image captured by the camera is fed back to the mobile terminal, and the captured image is viewed in real time through the mobile terminal.

18. The method of claim 10, further comprising a wireless fidelity (WIFI) module, which implements wireless network connections among electronic modules.
